(19) United States
(12) Patent Application Publication
(10) Pub. No.: US 2026/0073353 A1
(43) Pub. Date: Mar. 12, 2026

(54) METHOD FOR AUTOMATICALLY DETERMINING CONSUMPTION DATA OF MEDIA IN A FILLING LINE AND APPARATUS FOR CARRYING OUT THE METHOD

(71) Applicant: Krones AG, Neutraubling (DE)

(72) Inventor: Christoph BOGNER, Neutraubling (DE)

(21) Appl. No.: 19/105,250

(22) PCT Filed: Sep. 6, 2023
(86) PCT No.: PCT/EP2023/074460

§ 371 Date: Feb. 20, 2025

(30) Foreign Application Priority Data
Sep. 8, 2022 (DE) 102022122805.3

(51) Int. Cl. G06Q 10/087; G06Q 10/0639

(52) U.S. Cl. CPC G06Q 10/087; G06Q 10/0639

(57) ABSTRACT

The invention relates to a method for automatically determining consumption data of media (3, 5, 6, 8, 9, 42, 47, 53) in a filling line (1), comprising at least one media-consuming machine (2, 4, 7, 41, 46, 52). The consumption data comprises an actual amount (27, 28, 29, 30, 31) and a remaining operation time (33, 34, 35, 36, 37, 45, 50, 56) of the medium. The method comprises the steps of determining an actual amount (27, 28, 29, 30, 31) of a medium of the at least one machine and transferring the actual amount in a predefined format to an external storage means via an edge device, transferring context information (10) relating to the filling line and the at least one machine to the external storage means via the edge device, creating a consumption monitor comprising the consumption data of the media within an external storage means, determining a remaining operation time of the medium based on the actual amount of the medium and on the context information relating to the filling line and the at least one machine, transferring the consumption monitor to a display apparatus, displaying the consumption monitor by the display apparatus and using the consumption data when operating the filling line. The invention further relates to an apparatus for carrying out the method.

### RELATED APPLICATIONS

This application claims the benefit of International Patent Application No. PCT/EP2023/074460, filed Sep. 6, 2023, which claims priority to German Patent Application No. DE102022122805.3, filed Sep. 8, 2022. The entire contents of both applications are hereby incorporated by reference.

### TECHNICAL FIELD

The present disclosure relates to a method for automatically determining consumption data of media in a filling line and to an apparatus for carrying out the method according to the independent claims.

### BACKGROUND

It is known to display a consumable of a machine that is in a filling line at a human-machine interface of the relevant machine. A warning signal, for example in the form of a light, can be provided to indicate when the material is running low.

EP2815216 A1 discloses an apparatus for providing consumables for a packaging machine, wherein the apparatus comprises a magazine for the consumables and a detection apparatus for determining an actual amount of consumable material in the magazine. The detection device can be coupled to a display unit used to display the actual amount of consumable material in the magazine. The display unit can comprise a warning function with which a warning signal can be generated if the actual amount falls below a predefined minimum amount.

### SUMMARY

Provided herein is a method for automatically determining consumption data of media in a filling line and an apparatus for carrying out the method, which allows a cross-machine and cross-system display of consumption data of the media.

### BRIEF DESCRIPTION OF THE DRAWINGS

The accompanying drawings show, by way of example, aspects and/or exemplary embodiments of the invention for better understanding and illustration. In the drawings:

FIG. 1 shows a block diagram explaining part of the method, and

FIG. 2 shows a schematic consumption monitor.

### DETAILED DESCRIPTION

Described herein is a method for automatically determining consumption data of media in a filling line and an apparatus for carrying out the method. Further embodiments are additionally described herein.

In some embodiments, a method for automatically determining consumption data of media in a filling line which comprises at least one media-consuming machine, wherein the consumption data include an actual amount and a remaining operation time of the medium, comprising determining an actual amount of a medium of the at least one machine, transferring the actual amount in a predefined format to an external storage means via an edge device, transferring context information relating to the filling line and the at least one machine to the external storage means via the edge device, creating a consumption monitor comprising the consumption data of the media within an external storage means, determining a remaining operation time of the medium based on the actual amount of the medium and on context information relating to the filling line and the at least one machine, transferring the consumption monitor to a display apparatus, displaying the consumption monitor by the display apparatus, and using the consumption data when operating the filling line.

The actual amount of the medium can be determined on the basis of a fill level in a supply container. This can be provided, for example, for the glue medium, which may be provided in a glue container for use in a labeling machine of the filling line.

The actual amount can be determined by comparing the original quantity of medium provided with a quantity of the medium already used, for example during a production process in the filling line. This can be provided for the label medium, for example.

The actual amount can be determined by the number of ejected containers in a waste container and/or a fill level of the ejected containers in the waste container and/or by a weight the waste container with ejected containers therein compared to the empty waste container.

Since both the filling line and the media-consuming machine can have an influence on the consumption of the medium, not only is the actual amount of the medium taken into account to determine the remaining operation time of the medium, but also the context information relating to the filling line and the at least one machine.

The consumption data, which comprise the actual amount and the remaining operation time of the medium, can be used during operation to ensure that a medium can be topped up (glue, labels, closures, clips, preforms) or emptied (capacity, for example, of a waste container) in good time before the end of the operation time.

The at least one media-consuming machine may comprise a control unit. If there are a plurality of media-consuming machines, each of the machines can comprise a control unit. The control unit can be used to control the machine and can be configured, for example, as a computer with an assigned processor and (internal) storage means as well as suitable programming.

The external storage means can be provided outside each control unit of the media-consuming machines. The external storage means may not be part of any of the control units in some embodiments. The external storage means may be a data storage means or may comprise a data storage means.

The external storage means can be accessed from outside the filling line and/or the machine. The actual amount and the context information can be further processed in the external storage means.

Creating a consumption monitor comprising the consumption data of the media can be done, for example, within an external storage means. This external storage means may be different from the external storage means mentioned above, or this external storage means may correspond to the external storage means mentioned above. If this external storage means is different from the external storage means mentioned above, it can also be provided that this external storage means can be provided outside each control unit of the media-consuming machines. This external storage means may not be part of any of the control units in some embodiments.

The creation of the consumption monitor may not be provided in a machine control system in some embodiments. The method is a method for automatically determining consumption data of media in a filling line such that it may not be sufficient to take into account the at least one media-consuming machine. In one embodiment it is provided that the determination of the remaining operation time of the medium is based on the actual amount of the medium and on context information relating to the filling line. In addition to taking the at least one machine into account on its own, the filling line as a whole may thus also have to be taken into account. It can therefore be provided that the consumption monitor comprising the consumption data of the media can be created within the external storage means.

By transferring the consumption monitor to the display apparatus and displaying the consumption monitor using the display apparatus, the consumption data can be collected locally, the consumption monitor can be created within an external storage means and the consumption monitor can be transferred back to the media-consuming machine in order to display the consumption monitor.

The context information may comprise at least one of the following:
temporal progress of a production order in the filling line,
historical filling line performance and/or machine performance for the production order,
planned filling line performance and/or machine performance for the production order,
prioritization of the at least one machine and/or medium for the production order,
time required to top up/empty the medium,
type of production order, e.g., media required and/or machines used in the filling line.

The temporal progress of a production order in the filling line can be relevant to determine whether medium still needs to be topped up and/or emptied during this production order or whether the production order has already ended before requiring topping up and/or emptying.

From the historical filling line performance and/or machine performance for the production order, conclusions can be drawn about additional behavior of the filling line and/or the at least one machine at the same or different performance levels.

For example, if two different media need to be topped up, the prioritization of the medium for the production order can be relevant in order to determine which medium should be topped up first in order to prevent, for example, the filling line from stopping. For example, prioritization may specify that labels should be topped up first and then clips.

The time required to top up/empty the medium may be relevant to determine when to start topping up/emptying within the remaining operation time to prevent running out of the medium.

For example, the type of production order may mean that neck labels are not used. This avoids unnecessarily topping up neck labels.

The media may comprise at least one of the following: preforms, labels, glue, clips, closures, film, cardboard, pallets, capacities, for example in waste containers.

One of the at least one machine can use one medium or different media.

The consumption monitor can display the consumption data of the media across filling lines and machines. The consumption monitor can be accessed from outside the filling line and/or the machine as it can be created within the external storage means.

The consumption monitor may further comprise at least one of the following:
specification of the at least one machine,
specification of the medium consumed by the machine,
specification of a production order carried out in the filling line,
specification of a production order planned in the filling line,
specification of whether or not the medium requires topping up/emptying while the production order is executed,
specification of the time at which the consumption monitor was last updated.

The additional information provided by the consumption monitor allows for a clear association between the machine, the medium consumed by the machine (one medium, a plurality of different media that may require topping up or emptying) and requirements for topping up/emptying medium.

By specifying the production order carried out in the filling line, conclusions can be drawn as to which media are required therefor and, for example, how long the production order will last, assuming planned filling line performance and/or machine performance, before it ends and, if applicable, a planned production order can begin.

The consumption monitor can comprise a corresponding display region for the consumption data of each medium. The machine, the actual amount of medium (e.g., in percent) and the remaining operation time (e.g., in minutes) can be specified in the display region. If the actual amount is above a minimum value, the associated display region can be green or the information relating to the actual amount and the remaining operation time can be green. The minimum value may be different for different media. The minimum value may vary depending on the filling line performance and/or machine performance, but it may also be independent of the filling line performance and/or machine performance. If the actual amount of the medium falls below the minimum value, the associated display region can be orange or the information relating to the actual amount and the remaining operation time can be orange. If the actual amount is zero, the associated display region can be red or the information relating to the actual amount and the remaining operation time can be red. For example, if the data connection to the machine is interrupted, the associated display region may be gray.

The minimum value can be a dynamic minimum value.

For the dynamic minimum value, at least one of the following can be taken into account:
the position of an operator of the filling line or positions of a plurality of operators of the filling line, wherein, for example, the position of each operator can be determined by a mobile terminal and/or ID token and/or tablet and/or smartwatch assigned to the operator,
the number of operators of the filling plant,
the availability of one or more operators of the filling plant,
the actual amount of the medium is of such an amount that the remaining operation time for topping up or emptying ensures continuous operation of the filling line,
an average topping up or emptying time.

For example, the dynamic minimum value may be smaller if the operator is closer to the corresponding media-consuming machine. For example, the dynamic minimum value may be larger if the operator is further away from the corresponding media-consuming machine. A dynamic change from a first minimum value to a smaller, second minimum value can occur when the operator's position changes and they approach the corresponding machine. A dynamic change from a third minimum value to a larger, fourth minimum value can occur if the operator's position changes and they move away from the corresponding machine.

“Closer to the corresponding machine” or “further away from the corresponding machine” can mean a distance that the operator has to travel in the filling line. If a greater distance is to be covered, the dynamic minimum value may be greater than if the distance to be covered is smaller. In general, the distance to be covered cannot be equal to the shortest linear distance.

The method may comprise calculating the minimum value/dynamic minimum value. For example, the calculation of the minimum value can be done in one of the external storage means mentioned above.

The consumption monitor can be displayed by a central control station, for example a dashboard, and/or by a mobile terminal, for example a smartphone, laptop, and/or tablet. The central control station can be provided in a hall where the filling line is located. The mobile terminal can be handled by an operator who may be responsible for one or more machines in the filling line. Additionally or alternatively, the consumption monitor can be displayed on the HMI (human machine interface) of a machine that may be located within the filling line. For example, it can be advantageous for an operator to be responsible for displaying the consumption monitor on the HMI of a machine. The consumption monitor displayed to the operator on their mobile terminal can be additionally or alternatively displayed on an HMI if the operator is in the operating and/or field of vision of the HMI of one of the machines. Displaying the corresponding consumption monitor on the HMI can be manually or automatically initiated. Manually, for example, through manual intervention by the operator on the mobile terminal (by giving the command to transmit/mirror the consumption monitor on the HMI); automatically, for example, through the operator approaching an HMI, which can be detected by knowing the operator's position in the hall. The position in the hall can be determined, for example, using GPS data, sensors and/or cameras.

A notification can be sent to a mobile terminal, for example a smartphone, laptop, and/or tablet, if the actual amount and/or the remaining operation time fall below a relevant minimum value. An operator who is outside the filling line and/or outside a hall in which the filling line is located can be informed about the need to top up/empty medium. The properties already described above in connection with the minimum value and the dynamic minimum value can apply to the relevant minimum value. For example, the relevant minimum values can be dynamic minimum values.

The notification may comprise instructions for topping up/emptying the medium. The instructions may comprise information on the time required for topping up/emptying and/or information on how topping up/emptying is to be carried out.

The consumption monitor can be created for selecting the at least one machine on the basis of responsibility data. For example, if an operator is only responsible for a specific machine of the at least one machine, it may be sufficient to give the operator access to a consumption monitor that only relates to this specific machine.

The responsibility data may comprise a responsibility of an operator. The operator can be responsible for one or more of the at least one machine on the filling line.

The responsibility data can be determined on the basis of an operator's identity using recording data from a time clock. Data recorded by the time clock may be or be made accessible.

An apparatus is provided for carrying out the method, as described above or below.

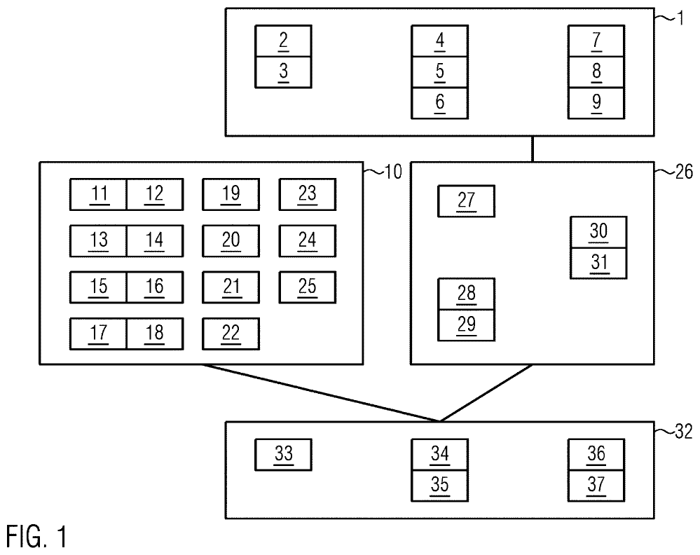

FIG. 1 shows a block diagram explaining part of the method, as described herein. A filling line 1 comprises, for example, three media-consuming machines 2, 4, 7. The first machine 2 consumes a first medium 3, the second machine 4 consumes a second medium 5 and a third medium 6, and the third machine 7 consumes a fourth medium 8 and a fifth medium 9. The actual amounts 26 of the different media 3, 5, 6, 8, 9 can be determined. For the first medium, a first actual amount 27 may be provided, for the second medium 5, a second actual amount 28 may be provided, for the third medium 6, a third actual amount 29 may be provided, for the fourth medium 8, a fourth actual amount 30 may be provided, and for the fifth medium 9, a fifth actual amount 31 may be provided.

The remaining operation times of the media 3, 5, 6, 8, 9 can be determined on the basis of the corresponding actual amount 27, 28, 29, 30, 31 of the medium 3, 5, 6, 8, 9 and on context information 10 relating to the filling line 1 and the machines 2, 4, 7.

The context information 10 can comprise current data 11 and planned data 12 of the filling line 1, current data 13 and planned data 14 of the first machine 2, current data 15 and planned data 16 of the second machine 4 and current data 17 and planned data 18 of the third machine 7.

In addition, the context information 10 can comprise historical data 19 of the filling line 1, historical data 20 of the first machine 2, historical data of the second machine 4 and historical data of the third machine 7.

Furthermore, the context information 10 can comprise prioritization data 23 relating to the first machine 2, prioritization data 24 relating to the second machine 4 and prioritization data 25 relating to the third machine 7.

Remaining operation times 32 of the medium can be determined on the basis of the corresponding actual amount 27, 28, 29, 30, 31 of the medium 3, 5, 6, 8, 9 and on context information 10 relating to the filling line 1 and the machines 2, 4, 7. For the first medium 3, a first remaining operation time 33 may be provided, for the second medium 5, a second remaining operation time 34 may be provided, for the third medium 6, a third remaining operation time 35 may be provided, for the fourth medium 8, a fourth remaining operation time 36 may be provided, and for the fifth medium 9, a fifth remaining operation time 37 may be provided.

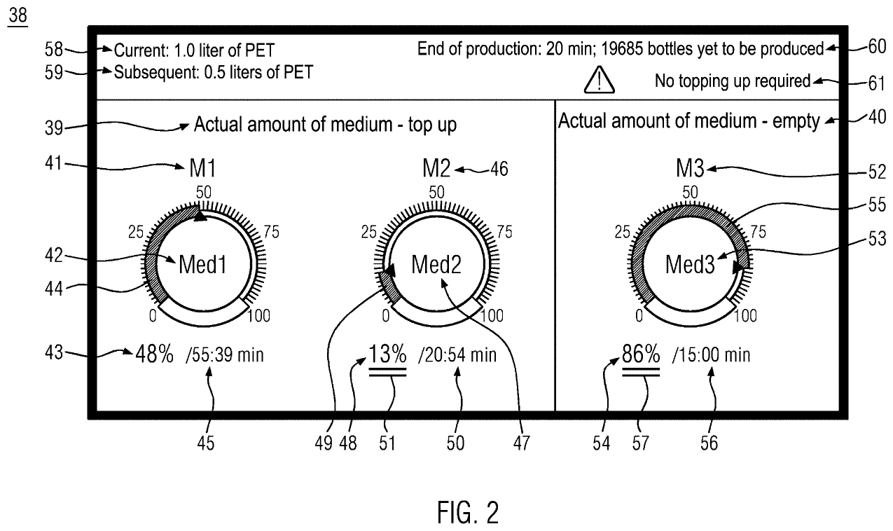

FIG. 2 shows a schematic consumption monitor 38. The representations and/or texts given here may be examples and other arrangements and embodiments are also conceivable. In this respect, the displayed values for the consumption and the like are merely examples and do not limit the present disclosure. The media which may need to be topped up are indicated in a first subportion 39, and the media that may need to be emptied are indicated in a second subportion 40.

A first machine 41 consumes a first medium 42. Its actual amount is given as numerical value 43 with 48% and is also marked as region 44. The remaining operation time 45 is given as 55:39 minutes. The actual amount may be above a minimum value so no designation that topping up is required may be provided.

A second machine 46 consumes a second medium 47. Its actual amount is given as numerical value 48 with 13% and is also marked as region 49. The remaining operation time 50 is given as 20:54 minutes. The actual amount is below a minimum value so that a designation 51—here by double-underlining the numerical value 48—provided because topping up may be required. However, as can be seen from a first piece of information 60 of the consumption monitor 38, production will end in 20 minutes and, as can be seen from a second piece of information 61, topping up may not be required. The remaining operation time 50 of the second medium 47 may be greater than the duration until the end of production.

A third machine 52 consumes a third medium 53. Its actual amount is given as numerical value 54 with 86% and is also marked as region 55. The actual amount indicates, for example, the fill level of a waste container. The remaining operation time 56 is given as 15:00 minutes. A designation 57—here by double-underlining the numerical value 54—is provided because emptying is required.

The consumption monitor 38 provides third pieces of information 58 regarding current production and fourth pieces of information 59 regarding planned production, wherein the type of bottle is given by way of example in this case.

It is to be understood that the above description is intended to be illustrative, and not restrictive. Other embodiments will be apparent upon reading and understanding the above description. Although embodiments of the present disclosure have been described with reference to specific example embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

1. A method for automatically determining consumption data of at least one medium in a filling line comprising at least one media-consuming machine, wherein the consumption data comprises an actual amount and a remaining operation time of a medium, wherein the method comprises:
determining the actual amount of the medium of the at least one machine;
transferring the actual amount in a predefined format to an external storage via an edge device;
transferring context information relating to the filling line and the at least one machine to the external storage via the edge device;
creating a consumption monitor comprising the consumption data of the media within the external storage;
determining the remaining operation time of the medium based on the actual amount of the medium and on the context information relating to the filling line and the at least one machine;
transferring the consumption monitor to a display apparatus;
displaying the consumption monitor by the display apparatus; and
using the consumption data when operating the filling line.

2. The method according to claim 1, wherein the context information comprises at least one of the following:
temporal progress of a production order in the filling line;
at least one of historical filling line performance or machine performance for the production order;
at least one of planned filling line performance or machine performance for the production order;
prioritization of one or more of the at least one machine or the medium for the production order;
time required to at least one of top up or empty the medium; or
type of production order indicative of at least one of media required or machines used in the filling line.

3. The method according to claim 1, wherein the media comprises at least one of:
preforms,
labels,
glue,
clips,
closures
film,
cardboard,
pallets, or
capacity in waste containers.

4. The method according to claim 1, wherein the consumption monitor further comprises at least one of the following:
specification of the at least one machine;
specification of the medium consumed by the machine;
specification of a production order carried out in the filling line;
specification of a production order planned in the filling line;
specification of whether or not at least one of topping up or emptying of medium is required while the production order is executed; or
specification of a time at which the consumption monitor was last updated.

5. The method according to claim 1, wherein the consumption monitor for each medium comprises a particular display region for the consumption data of the medium.

6. The method according to claim 1, wherein the consumption monitor is displayed by at least one of a central control station or by a mobile terminal.

7. The method according to claim 1, wherein a notification is sent to a mobile terminal if at least one of the actual amount or the remaining operation time fall below a relevant minimum value.

8. The method according to claim 7, wherein the notification comprises instructions for at least one of topping up or emptying the medium.

9. The method according to claim 7, wherein the minimum value is a dynamic minimum value.

10. The method according to claim 9, wherein at least one of the following is taken into account for the dynamic minimum value:
a position of an operator of the filling line or positions of a plurality of operators of the filling line, wherein, the position of each operator can be determined by at least one of a mobile terminal or identification (ID) token, a tablet, or a smartwatch assigned to the operator;
a number of operators of the filling line;
an availability of one or more operators of the filling line;
the actual amount of the medium is of such an amount that the remaining operation time for topping up or emptying ensures continuous operation of the filling line; or
an average topping up or emptying time.

11. The method according to claim 9, further comprising calculating the minimum value or the dynamic minimum value, wherein the calculating is carried out in the external storage.

12. The method according to claim 1, wherein the consumption monitor is created for selecting the at least one machine based on responsibility data.

13. The method according to claim 12, wherein the responsibility data comprises a responsibility of an operator.

14. The method according to claim 12, wherein recording data from a time clock is used to determine the responsibility data based on an identity of an operator.

15. An apparatus, comprising:
a filling line comprising at least one media-consuming machine; and
a processing device configured to automatically determine consumption data of media in the filling line, wherein the consumption data comprises an actual amount and a remaining operation time of a medium, wherein the processing device is configured to perform operations comprising:
determine the actual amount of the medium of the at least one machine;
transfer the actual amount in a predefined format to an external storage via an edge device;
transfer context information relating to the filling line and the at least one machine to the external storage via the edge device;
create a consumption monitor comprising the consumption data of the media within the external storage;
determine the remaining operation time of the medium based on the actual amount of the medium and on the context information relating to the filling line and the at least one machine;
transfer the consumption monitor to a display apparatus;
display the consumption monitor by the display apparatus; and
use the consumption data when operating the filling line.

16. The apparatus according to claim 15, wherein the context information comprises at least one of the following:
temporal progress of a production order in the filling line;
at least one of historical filling line performance or machine performance for the production order;
at least one of planned filling line performance or machine performance for the production order;
prioritization of one or more of the at least one machine or the medium for the production order;
time required to at least one of top up or empty the medium; or
type of production order indicative of at least one of media required or machines used in the filling ling.

17. The apparatus of claim 15, wherein the media comprises at least one of preforms, labels, glue, clips, closures, film, cardboard, pallets, or capacity in waste containers.

18. The apparatus of claim 15, wherein the consumption monitor further comprises at least one of the following:
specification of the at least one machine;
specification of the medium consumed by the machine;
specification of a production order carried out in the filling line;
specification of a production order planned in the filling line;
specification of whether or not at least one of topping up or emptying of medium is required while the production order is executed; or
specification of a time at which the consumption monitor was last updated.

19. The apparatus of claim 15, wherein the consumption monitor for each medium comprises a particular display region for the consumption data of the medium.

20. The apparatus of claim 15, wherein the consumption monitor is displayed by at least one of a central control station or by a mobile terminal.
